(19) United States
(12) Patent Application Publication
(10) Pub. No.: US 2015/0026058 A1
(43) Pub. Date: Jan. 22, 2015

(54) Payment System

(71) Applicant: BC Investment & Leasing, Inc., Fargo, ND (US)

(72) Inventor: Bryan J. Smith, Fargo, ND (US)

(21) Appl. No.: 14/472,971

(22) Filed: Aug. 29, 2014

Related U.S. Application Data
(63) Continuation-in-part of application No. 13/658,079, filed on Oct. 23, 2012.
(60) Provisional application No. 61/550,634, filed on Oct. 24, 2011.
(60) Provisional application No. 61/550,634, filed on Oct. 24, 2011.
(60) Provisional application No. 61/871,694, filed on Aug. 29, 2013.

(51) Int. Cl. G06Q 20/10

(52) U.S. Cl. CPC G06Q 20/108; G06Q 40/02
USPC 705/42

(57) ABSTRACT

A payment system for rapidly facilitating funds transfers from a payer to a payee. The payment system generally includes enrolling a payee with a payer, verifying the payee information, sending an introductory message to the payee, receiving an acceptance message from the payee, receiving a funds request message from the payee, depositing funds into a payee financial institution and sending a funds deposited message to payee. In an alternative embodiment, a customer initiated payment system allows customers to initiate payments to a merchant.

### CROSS REFERENCE TO RELATED APPLICATIONS

I hereby claim benefit under Title 35, United States Code, Section 120 of U.S. patent application Ser. No. 13/658,079 filed Oct. 23, 2012 (Attorney Docket No. INTE-032). This application is a continuation-in-part of the Ser. No. 13/658,079 application. The Ser. No. 13/658,079 application is currently pending. The Ser. No. 13/658,079 application is hereby incorporated by reference into this application. The Ser. No. 13/658,079 claims priority to U.S. Provisional Patent Application No. 61/550,634.

I hereby claim benefit under Title 35, United States Code, Section 119(e) of U.S. provisional patent application Ser. No. 61/550,634 filed Oct. 24, 2011 (Attorney Docket No. INTE-030). The Ser. No. 61/550,634 application expired after Oct. 24, 2012. The Ser. No. 61/550,634 application is hereby incorporated by reference into this application.

I hereby claim benefit under Title 35, United States Code, Section 119(e) of U.S. provisional patent application Ser. No. 61/871,694 filed Aug. 29, 2013 (Attorney Docket No. INTE-043). The Ser. No. 61/871,694 application is currently pending. The Ser. No. 61/871,694 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to electronic funds transfer and more specifically it relates to a payment system for rapidly facilitating funds transfers from a payer to a payee.

2. Description of the Related Art

Any discussion of the related art throughout the specification should in no way be considered as an admission that such related art is widely known or forms part of common general knowledge in the field.

Electronic funds transfer is the electronic transfer of money from one account to another account, either within a single financial institution or across multiple institutions through computer-based systems. Electronic funds transfer is comprised of various financial transactions such as credit card payments, direct deposit payroll payments, direct debit payments (a.k.a. electronic checks), electronic bill payment, and wire transfers. There are four main types of electronic funds transfer currently available for transferring money to consumers: bank wire transfers, cash wire transfers, automated clearing house (ACH) transfers and interbank transfers.

Bank wire transfers are one of the fastest ways to send money because there is an agreement setup between the banks allowing for the transfer to take place. Bank wire transfers can take place the same day (sometimes within minutes) because they are a bank-to-bank transaction (without using a clearinghouse) that allows money to move from Bank Account A directly to Bank Account B. When a wire transfer occurs, the account holders and the amount of money in each account are verified to ensure a fast, reliable and secure transaction. In the United States, domestic wire transfers are governed by Federal Regulation J and by Article 4A of the Uniform Commercial Code. In addition, domestic bank to bank wire transfers are conducted through the Fedwire system which uses the Federal Reserve System and its assignment of routing transmit number to uniquely identify each bank. While wire transfers are fast, reliable and secure, the financial institutions typically charge a fee for transferring and receiving the funds (e.g. $20 to $35 to send a wire transfer and $10 to $20 to receive a wire transfer).

Cash wire transfers do not involve sending money between bank accounts, but instead involve receiving cash from a sender at Location A of a business and providing cash to a recipient at Location B of the same business. In a cash wire transfer, an individual physically provides cash to a business (e.g. MONEYGRAM®, WESTERN UNION®) at Location A and pays a fee. The business then verifies the cash transfer to Location B and then Location B provides the cash to the recipient. A typical cash wire transfer can take as little as 10 minutes making them a fast method of transferring cash. While cash wire transfers are fast, the business performing the cash wire transfer typically charges a fee of between $10 to $25 per transfer. In addition, the sender and receiver of the cash must both be physically present at the respective location of the business performing the cash wire transfer. Finally, cash wire transfers are susceptible to fraud since the recipient can provide a false identity.

An automated clearing house (ACH) transaction is accomplished with the help of an “automated clearing house” and is not performed directly as with wire transfers. The automated clearing house is basically an electronic network for financial transactions that processes large volumes of credit and debit transactions in batches. Examples of ACH transactions occur when a user pays a bill online or uses a debit card. When an individual or business arranges for the electronic transfer of funds via ACH, all of the information is included in a “batch” which is sent to the clearing house. Additionally, banks receive their ACH transactions all in one batch and processed as a single transaction. The batch transfer of money via ACH simplifies the process because each individual transaction does not need individual attention because it is automated. Because ACH transactions do not require individual attention, the transfer fee is typically only between 2.5 cents to 25 cents per transaction. While ACH transactions are less expensive than wire transfers, the recipient of the money must wait for the batch to be process which can take between 1 to 3 days.

Interbank transfers are similar to bank wire transfers with the exception that the transfer occurs through an interbank network (a.k.a. ATM consortium or ATM network). In addition, interbank transfers typically utilize a third-party (e.g. FISERV®) that controls the transfer of funds between various different financial institutions that are part of the interbank network. Interbank transfers are commonly utilized for debit card payments and cash withdrawals. The main advantage of interbank transfers is the funds transfer is not processed by Fedwire making them faster than a bank wire transfer. Another advantage of interbank transfers is they are handled automatically within the interbank network making the transaction fee significantly lower than a bank wire transfer (typically around $1 per transaction). The main problem with an interbank transfer is that both financial institutions must be a member of the interbank network for the transfer of funds to occur whereas the ACH system does not have this limitation. Hence, if a financial institution is not a member of the interbank network, they are not able to transfer or receive funds via the interbank network.

Because of the inherent problems with the related art, there is a need for a new and improved payment system for rapidly facilitating funds transfers from a payer to a payee.

### BRIEF SUMMARY OF THE INVENTION

The invention generally relates to an electronic funds transfer system which includes enrolling a payee with a payer, verifying the payee information, sending an introductory message to the payee, receiving an acceptance message from the payee, receiving a funds request message from the payee, depositing funds into a payee financial institution and sending a funds deposited message to payee. In an alternative embodiment, a customer initiated payment system allows customers to initiate payments to a merchant.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram illustrating the various communication channels between parties utilizing the present invention.

FIG. 2 is a block diagram illustrating an exemplary communications network for the present invention.

FIG. 3 is a flowchart illustrating payee enrollment with a payer.

FIG. 4 is a flowchart illustrating confirmation of the payee via text message.

FIG. 5 is a flowchart illustrating the overall process of requesting and transferring funds from a payer to a payee.

FIG. 6 is a flowchart illustrating the overall messaging system.

FIG. 7a is an exemplary illustration of a payee device showing an introductory message.

FIG. 7b is an exemplary illustration of a payee device showing an acceptance message from the payee.

FIG. 7c is an exemplary illustration of a payee device showing a confirmation message.

FIG. 7d is an exemplary illustration of a payee device showing a funds request message.

FIG. 7e is an exemplary illustration of a payee device showing funds deposited message.

FIG. 8a is a flowchart illustrating an alternative embodiment that creates a customer initiated payment.

FIG. 8b is a continuation of the flowchart from FIG. 8a illustrating the alternative embodiment that creates the customer initiated payment.

FIG. 9 is a flowchart illustrating the alternative embodiment of the customer initiated payment.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures, processes and code described in this detailed description are typically stored on a computer readable storage medium, which may be any device or medium that can store code and/or data for use by a computer system. This includes, but is not limited to, magnetic and optical storage devices such as read-only memory, random-access memory, disk drives, magnetic tape, CDs (compact discs), DVDs (digital video discs), and computer instruction signals embodied in a transmission medium (with or without a carrier wave upon which the signals are modulated). For example, the transmission medium may include a communications network 10, such as the Internet and/or cellular phone network. The computer readable medium can also be distributed over a network 10 coupled computer systems so that the computer readable code is stored and executed in a distributed fashion.

The present invention may be embodied within various languages and technologies such as, but not limited to, JAVA, JAVASCRIPT, JSCRIPT, WMLSCRIPT, ACTIVEX, CGI, scripts, plug-ins, BASIC, VISUAL BASIC, C, C++, COBOL, FORTRAN, ADA, HTML, DHTML, XML, SGML, WML, HDML, FLASH, SHOCKWAVE, GIF, JPEG, ADOBE ACROBAT, PDF, MICROSOFT WORD, and PASCAL. The present invention may be operated upon various operating systems such as but not limited to ANDROID, UNIX, MACINTOSH, LINUX, WINDOWS, PALMOS, EPOC, WINDOWS CE, FLEXOS, OS/9, and JAVAOS.

The present invention utilizes a plurality of conventional computers to receive, transmit and store electronic data. A conventional computer preferably includes a display screen 24 (or monitor), a printer, a hard disk drive, a network 10 interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen 24, a printer device, a hard disk drive, and a network 10 interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the present invention. For example, pointing devices such as a computer mouse, a track ball, a stylus, or a tablet to manipulate a pointer on a screen of the computer system. The display screen 24 is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor together with an operating system operate to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape.

The network 10 interface circuit is utilized to send and receive data over a network 10 connected to other computer systems. An interface card or similar device and appropriate software implemented by microprocessor can be utilized to connect the computer system to an existing network 10 and transfer data according to standard protocols.

The present invention may be deployed via various types of electronic devices including, but not limited to, computers (e.g. desktop, laptop, tablet), server computers, cloud-based computers, mobile phones and the like. The present invention may also be deployed in various software based environments such as, but not limited to, application software, mobile applications and the like.

### A. Overview of Invention.

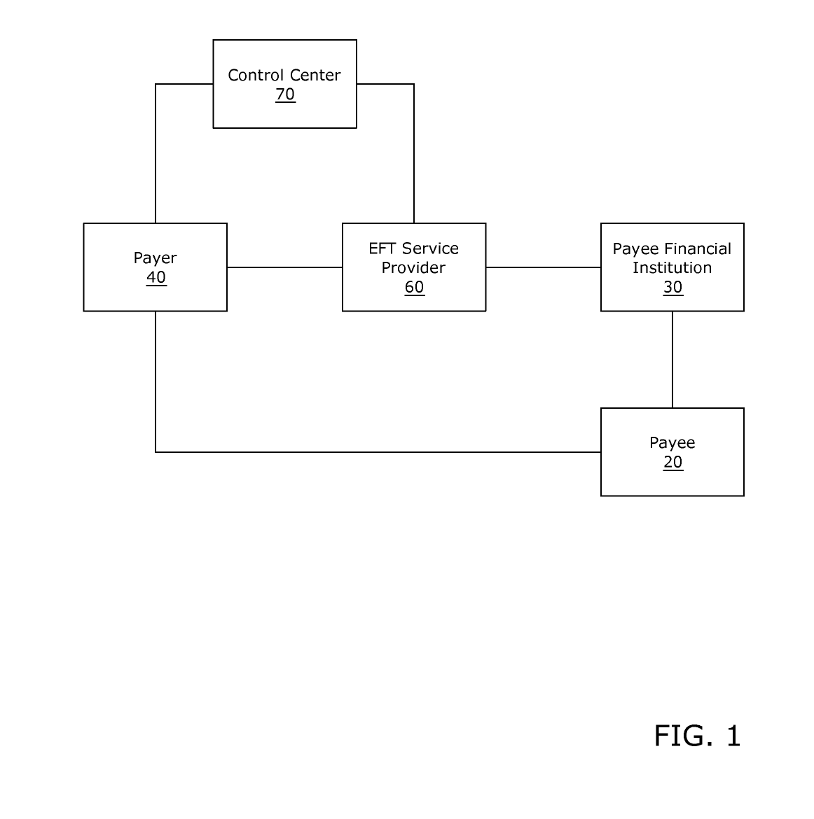

FIGS. 1 through 8 illustrate the present invention. The payment system generally includes enrolling a payee 20 with a payer 40, verifying the payee information, sending an introductory message 50 to the payee 20, receiving an acceptance message 51 from the payee 20, receiving a funds request message 53 from the payee 20, depositing funds into a payee financial institution 30 and sending a funds deposited message 54 to payee 20. FIG. 1 of the drawings illustrates the general communications between the payer 40, the payee 20, the control center 70, the EFT service provider 60 and the payee financial institution 30. The present invention is preferably implemented in an automated manner to ensure expedited processing of fund requests by the transfer. The present invention is further preferably implemented utilizing a text messaging system with a mobile device via an application on the mobile device (e.g. an existing text messaging application on the mobile device or a downloaded mobile application specifically designed for use with the present invention).

### B. Exemplary Telecommunications Network(s).

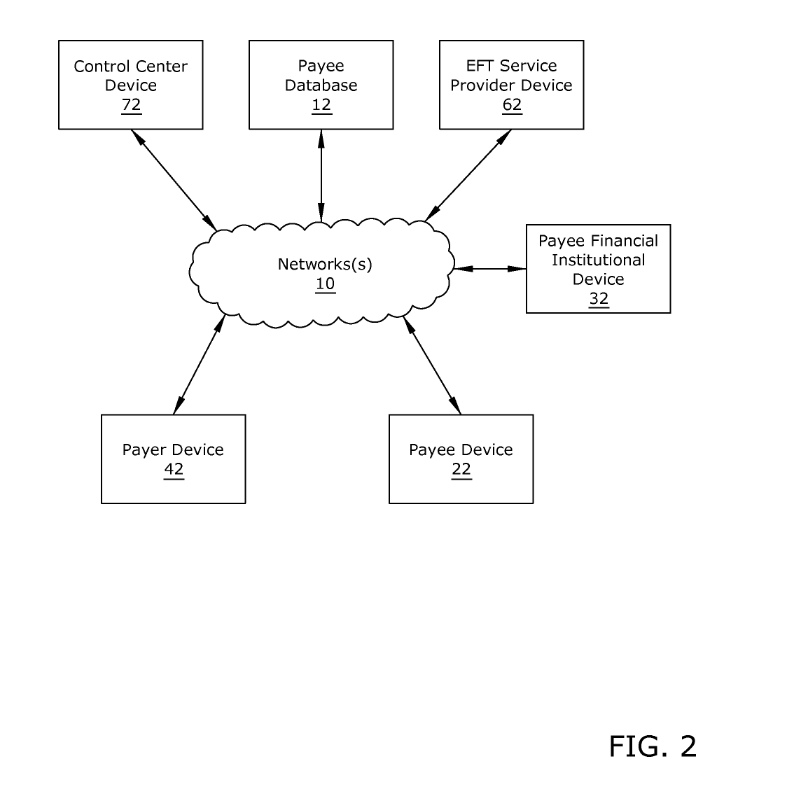

The present invention may be utilized upon any telecommunication network 10 capable of transmitting electronic data and/or electronic funds between a plurality of electronic devices (e.g. computers, mobile devices, etc.). The present invention may communicate via a single telecommunication network 10 or multiple telecommunication networks 10 concurrently. In particular, the payee device 22, the payer device 42, the payee financial institution device 32, the EFT service provider device 62, the payee database 12, the control center device 72 and various other devices utilized within the present invention preferably communicate with one another via one or more networks 10 as illustrated in FIG. 2 of the drawings.

Examples of suitable telecommunication networks 10 for the present invention include, but are not limited to, global computer networks 10 (e.g. Internet), closed computer networks 10 (a.k.a. intranets), financial networks 10, interbank networks 10 (a.k.a. ATM consortium or ATM network 10), wireless networks 10, telephone networks 10, cellular networks 10, satellite communications networks 10, cable communication networks 10 (e.g. via a cable modem), microwave communications network 10, local area networks 10 (LAN), wide area networks 10 (WAN), campus area networks 10 (CAN), metropolitan-area networks 10 (MAN), and home area networks 10 (HAN). Various protocols may be utilized by the electronic devices for communications such as but not limited to HTTP, SMTP, FTP and WAP (wireless Application Protocol). The present invention may be implemented upon various wireless networks 10 such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and internet service providers.

The Internet is an exemplary communications network 10 for the present invention. The Internet is basically comprised of a “global computer network 10.” A plurality of computer systems around the world are in communication with one another via this global computer network 10 and are able to transmit various types of data between one another. The communications between the computer systems may be accomplished via various methods such as but not limited to wired, wireless, Ethernet, cable, direct connection, telephone lines, and satellite.

### D. Payee.

The payee 20 is any individual or business that requires funds transferred into the payee's account at a payee financial institution 30 (e.g. bank, credit union). The present invention is capable of being utilized with a plurality of different payees 20 and a plurality of different payers 40.

The payee's account maybe comprised of a conventional transactional account (e.g. checking account) or an account associated with a prepaid debit card (a.k.a. prepaid credit cards, open system prepaid cards, etc.). The payee's account also preferably has a debit card associated with the payee's account whereby the payee's account is connected to an interbank network 10 to allow for the efficient transfer of funds to and from the account.

In the present invention, the payee 20 establishes a relationship with a payer 40 and enters into a contractual arrangement whereby the payer 40 provides funds on demand to payee 20 in a preapproved manner. The relationship may be for a short-term loan (e.g. payday loan, payday advance, cash advance, prearranged line of credit). The payer 40 typically establishes predetermined transfer limits on the amount of funds preapproved to transfer to the payee 20 (e.g. a transaction limit of $200, a total daily limit of $400, a total weekly limit of $1,000).

The payee device 22 is utilized by the payee 20 to communicate via a network 10. The payee device 22 is an electronic device capable of receiving, transmitting and storing data such as but not limited to a computer. The payee device 22 is preferably comprised of a mobile device that may be comprised of any type of computer for practicing the various aspects of the present invention. For example, the mobile device can be a personal computer (e.g. APPLE® based computer, an IBM based computer, or compatible thereof) or tablet computer (e.g. IPAD®). The mobile device may also be comprised of various other electronic devices capable of sending and receiving electronic data including but not limited to smartphones, mobile phones, telephones, personal digital assistants (PDAs), mobile electronic devices, handheld wireless devices, smart phones, communicators, video viewing units, television units, television receivers, cable television receivers, pagers, communication devices, and digital satellite receiver units.

### E. Payee Financial Institution.

The payee financial institution 30 is comprised of a financial institution that the payee 20 has a financial account with where funds may be transferred to and from. The payee financial institution 30 may be comprised of various financial entities such as but not limited to a bank or credit union. The payee's financial account may also be comprised of various financial accounts such as but not limited to a checking account, a savings account, a debit card account or a pre-paid debit account.

The payee financial institution device 32 is utilized by the payee financial institution 30 to store payee information, payee's account information, fund transfer information, and various other types of electronic information relating to electronic funds transfer. The payee financial institution device 32 also communicates with the EFT service provider device 62, the control center device 72 and/or the payee database 12 via the network 10 (e.g. global computer network). The payee financial institution device 32 is comprised of an electronic device capable of receiving, transmitting and storing electronic data such as but not limited to a computer.

### F. Payer.

The payer 40 is any individual or business that provides for the transfer of funds to a payee 20 and the payee's bank account. The payer 40 may be comprised of various financial institutions including but not limited to banks, credit unions or payday lenders. The payer 40 may directly or indirectly provide funds via an electronic funds transfer to a payee 20. The payer 40 may utilize a third-party financial institution to provide the requested funds to the payee 20 and deposit the requested funds in the payee's account.

The payer device 42 is utilized by the payer 40 to store payee information, fund transfer information, and various other types of electronic information relating to electronic funds transfer. The payer device 42 also communicates with the EFT service provider device 62, the control center device 72 and/or the payee database 12 via the network 10 (e.g. global computer network). The payer device 42 is comprised of an electronic device capable of receiving, transmitting and storing electronic data such as but not limited to a computer.

### G. EFT Service Provider.

The electronic funds transfer (EFT) service provider 60 is any business that facilitates the electronic exchange, transfer of funds from one account to another account within a single financial institution or across multiple financial institutions. The EFT service provider 60 electronically transfers the funds via a computer-based system.

The EFT service provider 60 may transfer the money in various manners including bank wire transfers, an automated clearing house (ACH) or interbank transfer. It is preferable that the EFT service provider 60 electronically transfer funds utilizing either a bank wire transfer or an interbank transfer to transfer the funds in real-time or within minutes of a funds request by a payee 20 without significant delay. It is preferable that the transfer of funds by the EFT service provider 60 occur within 15 minutes after the request for funds by a payee 20.

It is further preferable that the EFT service provider 60 electronically transfer funds utilizing an interbank transfer which have a relatively low transactional cost and faster than a conventional bank wire transfer. Interbank transfers are similar to bank wire transfers with the exception that the transfer occurs through an interbank network 10 (a.k.a. ATM consortium or ATM network). The EFT service provider 60 is preferably an entity that transfers funds electronically between various financial institutions that are part of the interbank network 10. Because interbank transfers are limited to fund transfers between financial institutions that are members of the interbank network 10, more than one EFT service provider 60 may be utilized to ensure the ability to transfer funds between most financial institutions.

### H. Control Center.

The control center 70 controls the overall process for the present invention including receiving and sending text messages relating to the fund transfer request. The control center 70 may be a financial institution or an entity that is not a financial institution. The control center 70 may be an entity separate from the EFT service provider 60 thereby allowing for multiple EFT service providers 60 to utilize the system controlled by the control center 70.

Alternatively, the control center 70 and the EFT service provider 60 may be the same entity (the EFT service provider 60 can determine if they want to offer their service to other EFT service providers 60). In addition, the control center 70 may be comprised of the payer 40 or the financial institution utilized by the payer 40. For the purposes of discussion herein, the term control center 70 will be utilized separate from EFT service provider 60, the payer 40 and the financial institution used by the payer 40, wherein the control center 70 may be comprised of any of these entities without being separate from the same.

### I. Payee Database.

The payee database 12 is an electronic database hosted on a computer. The payee database 12 may be hosted in a cloud environment, on a web server computer or on a local computer (e.g. local server) of the control center 70. The payee database 12 receives, stores and transmits data relating to the payee 20 enrolled with the payer 40. It is preferable that the payee database 12 includes payee information relating to the payee 20 such as but not limited to a payee ID, name, address, e-mail address, telephone number, mobile phone number, bank account information, financial institution account number, name of payee's financial institution, security code, password, funds transfer limits set by the payer 40, name of the payer 40, name of the payer's financial institution, the payer's financial account for transfers and the like.

The payee ID is an identifier (e.g. customer number, etc.) that uniquely identifies the payee 20 within the payee database 12 and is utilized by the financial institutions in the present invention to identify the payee 20. The mobile phone number is the number utilized to send text messages to and from the payee 20. The account number is comprised of the financial account within a financial institution the payee 20 desires funds to be transferred to (e.g. checking account, prepaid debit card account, etc.). The security code is comprised of a code specific to the payee 20 and utilized by the payee 20 when requesting funds from the payer 40. The password is for providing access to the payee information by the payee 20 via online whereby the payee 20 can view and edit the payee information as stored within the payee database 12.

The funds transfer limits are limits set on the transfer of funds by the payer 40 such as but not limited to number of transactions per day, single transaction funds limit (e.g. $200/transaction limit), daily funds transfer limit (e.g. $400/day), weekly funds transfer limit (e.g. $1,000/week), day of week limits, time of day transfer limits and the like. The funds transfer limits stored within the payee database 12 may be adjusted at any time by the payer 40 via the payer device 42 based upon various factors such as change in the financial situation of the payee 20 or fraud detection.

Based on the funds transfer limits stored within the payee database 12, the control center 70 automatically determines whether a funds request by the payee 20 should be approved or disapproved for transfer from the payer 40 to the payee 20 by the EFT service provider 60. Alternatively, the control center 70 may seek prior approval of a funds transfer request from the payer 40 prior to authorizing the transfer of funds via the EFT service provider 60.

### J. Communications Between Parties.

The present invention preferably utilizes the quick exchange of information between the payee 20 and the control center 70. In particular, it is preferable to utilize real-time telecommunications where the relevant parties electronically exchange information instantly or with negligible latency to expedite the transfer of funds from the payer 40 to the payee 20. The exchange of information may have slight delays (e.g. 5 minutes, 10 minutes or 15 minutes), however, it is preferable that the entire process of requesting funds by the payee 20 to the transfer of funds to the payee 20 occur within less than 15 minutes and not exceed 15 minutes.

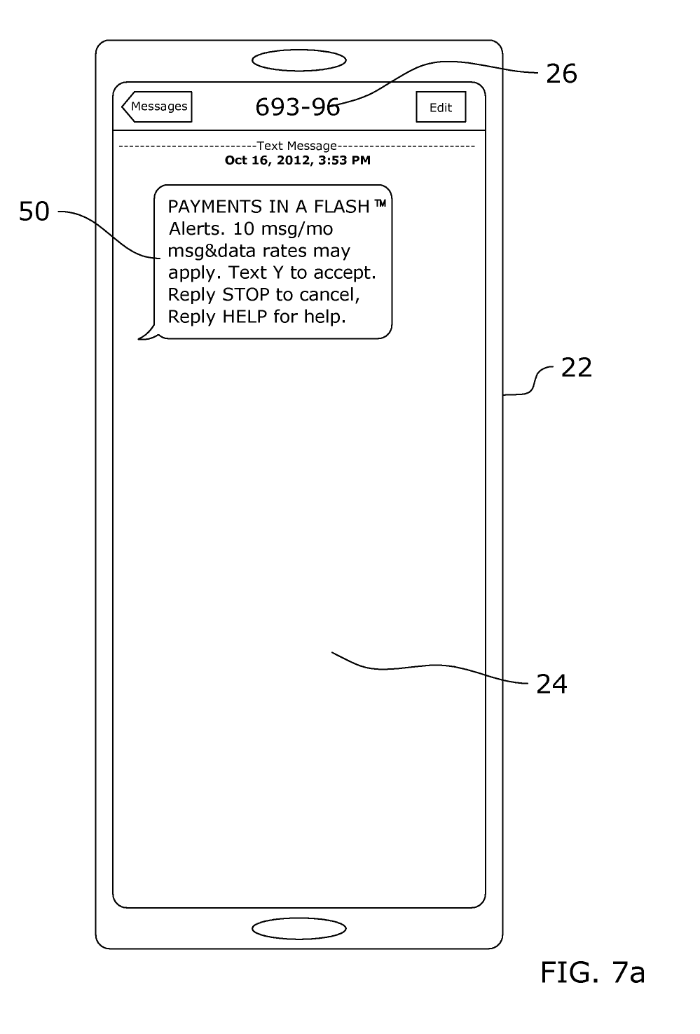

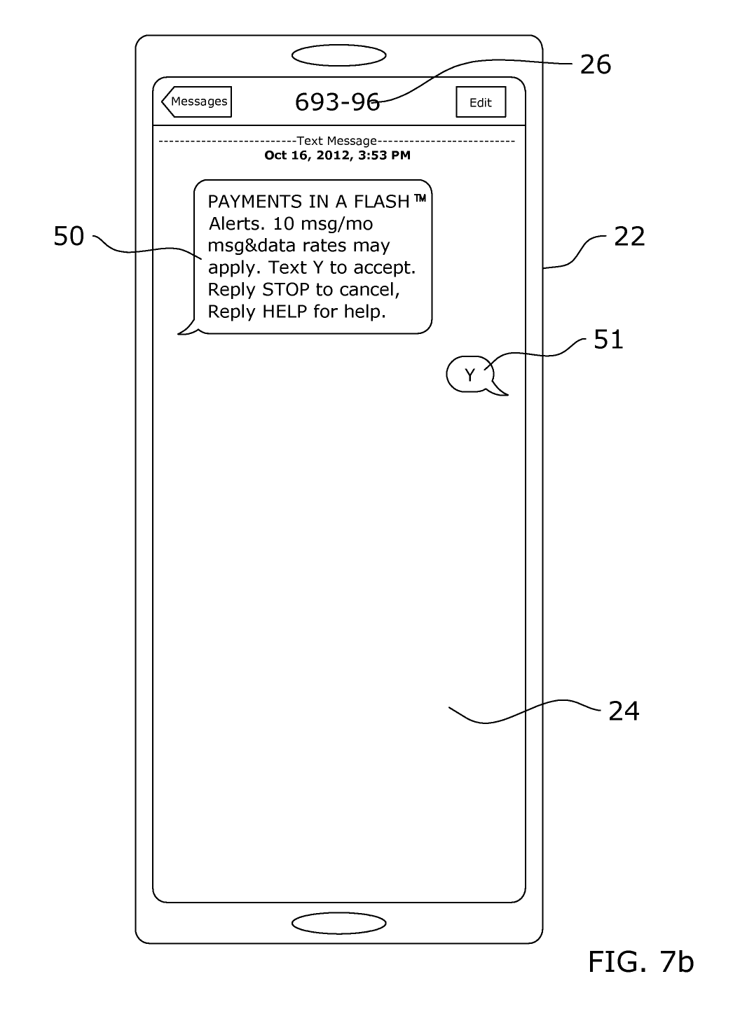

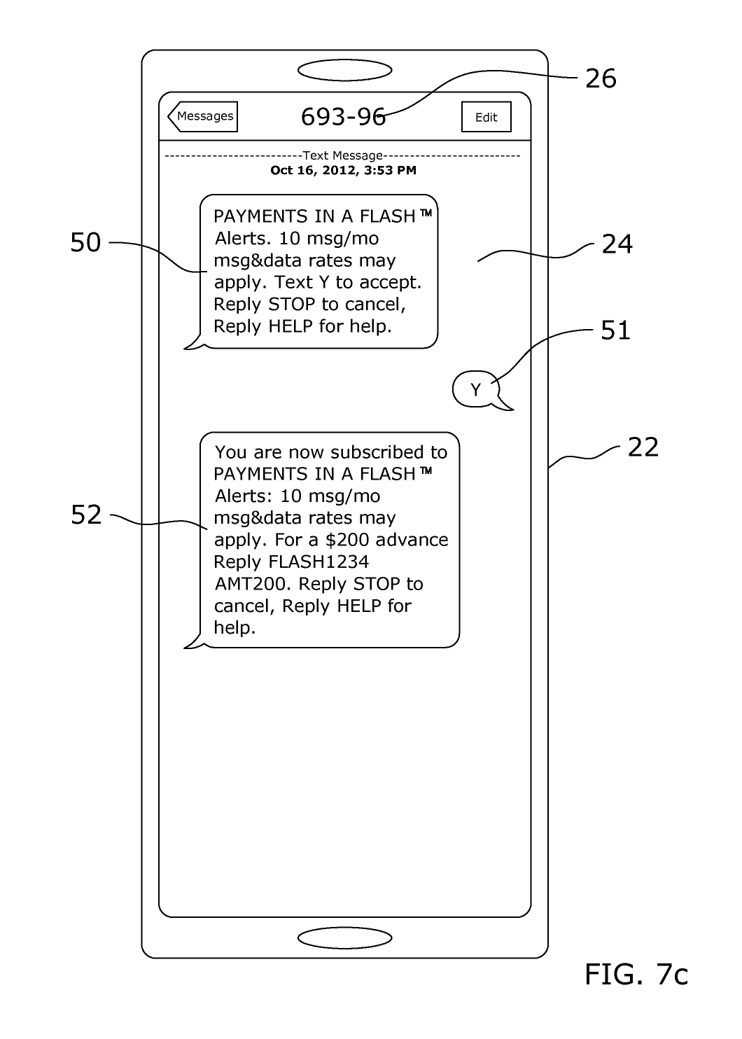

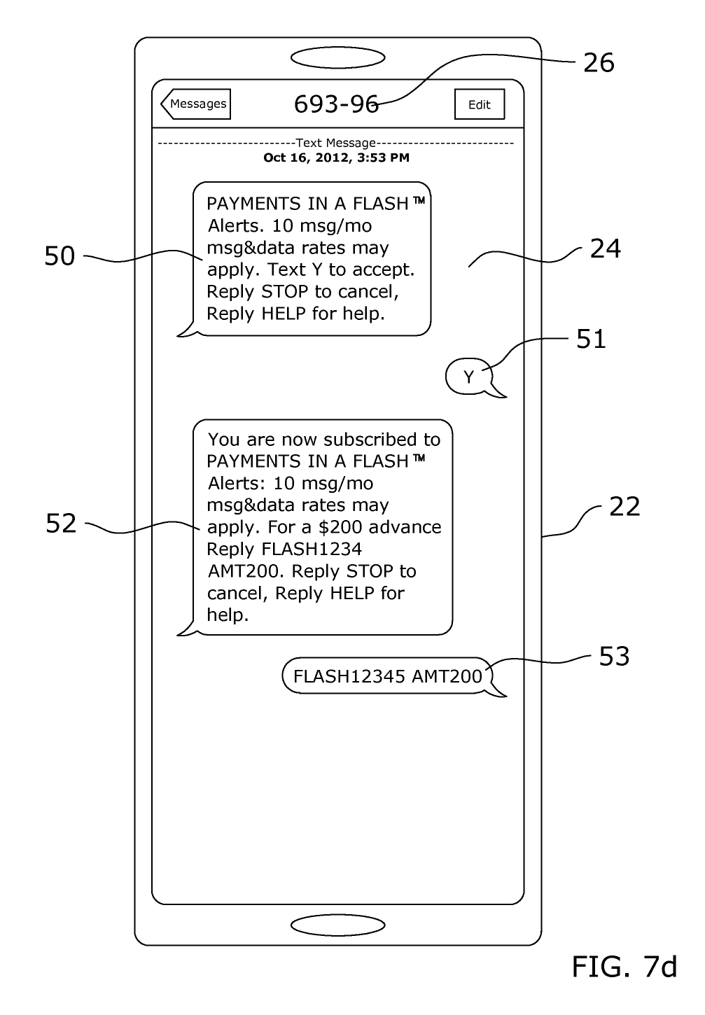

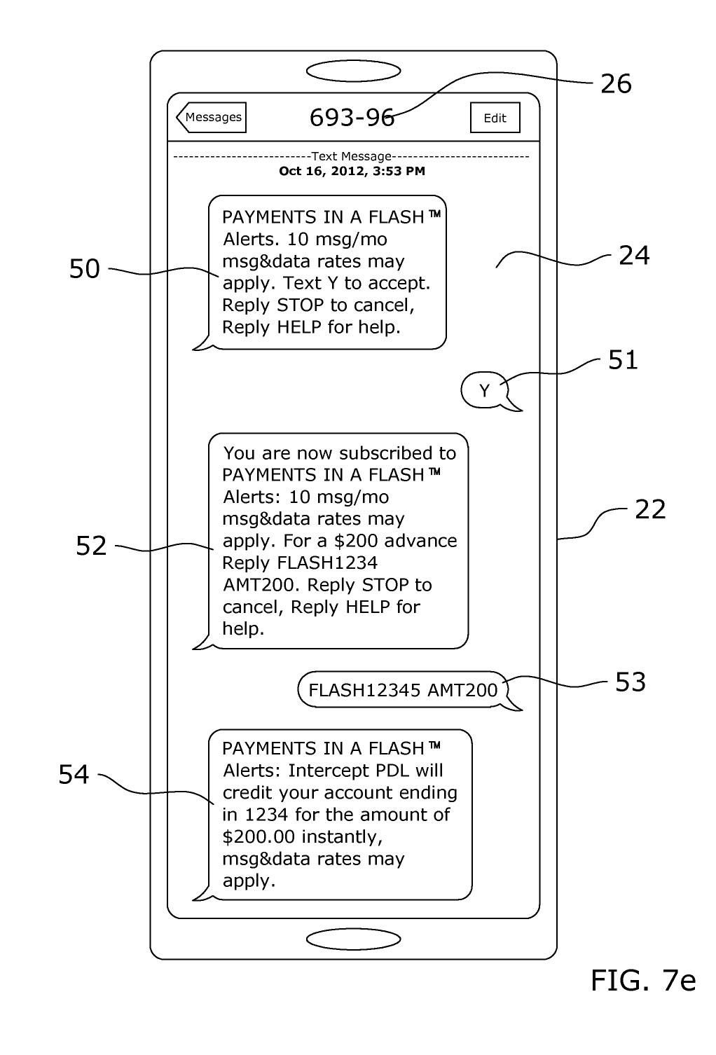

FIGS. 7a through 7e illustrate exemplary messages 50, 51, 52, 53, 54 exchanged between the payee 20 and the control center 70. The messages 50, 51, 52, 53, 54 are preferably text-based messages from the sender to the receiver transmitted via one or more telecommunications networks 10. The messages 50, 51, 52, 53, 54 may be comprised of various types of electronic communications including but not limited to instant messaging (IM), text messaging, messaging utilizing a mobile phone application and other types of electronic text-based communications between two parties.

The preferred embodiment of the present invention involve text messages between the control center 70 and the payee device 22, wherein the payee device 22 is preferably comprised of a mobile device (e.g. mobile phone). Various text messaging services may be utilized for the text messages such as but not limited to MMS, TMS or SMS, however, it is preferable that SMS (short message service) be utilized for communications between the control center 70 and the payee device 22.

### K. Operation of Preferred Embodiments.

1. Enrollment of Payee.

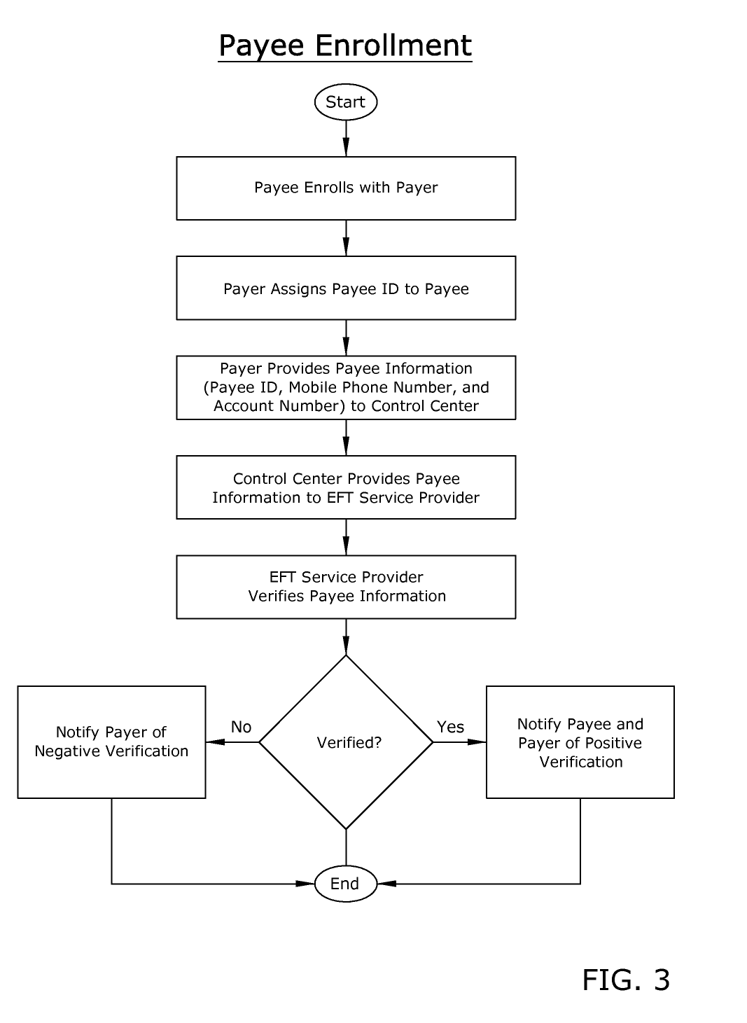

The payee 20 first enrolls with a payer 40 as illustrated in FIG. 3 of the drawings. The payee 20 may enroll with the payer 40 in various manners such as but not limited to via the payer's website, via a mobile phone application or in-person at a physical location of the payer 40. The payee device 22 used by the payee 20 for enrollment may be comprised of a computer (e.g. laptop, mobile device, smartphone, etc.). Various types of enrollment data is requested by the payer 40 of the payee 20 such as name, address, salary, employer identification, e-mail address, telephone number, mobile phone number, bank account information, financial institution account number, name of payee's financial institution, password, desired amount of funds and the like.

The payer 40 evaluates the payee information provided by the payee 20 and determines if the payee 20 should be approved for an immediate funds transfer and/or future funds transfer in a preapproved manner. If the payee 20 is preapproved for future fund transfers, it is preferable that various funds transfer limits are set by the payer 40 (e.g. daily transfer limit, etc.). For example, the payer 40 could preapprove payee 20 A for an immediate funds transfer of $500 and future funds transfers of $200/transaction with a $400/day limit.

After the payee 20 is approved by the payer 40 for future fund transfers, a payee ID is assigned to the payee 20 that is utilized by the payer 40, the EFT service provider 60 and the control center 70 to identify the payee 20 and communicate regarding the funds transfer for a specific payee 20. In addition, a security code is generated that is required to be used by the payee 20 when requesting funds. Furthermore, the mobile phone number associated with the payee 20 and the payee device 22 are utilized to identify the payee 20 to ensure security within the system.

2. Verification of Payee.

After the payee 20 is enrolled with the payer 40, the payee information is communicated to the EFT service provider 60 to verify that the payee information (e.g. name, account number) is valid. The EFT service provider 60 verifies with the payee financial institution 30 that the payee information is valid and that a fraudulent enrollment has not occurred.

If the payee 20 is verified, the payee 20, the control center 70, the EFT service provider 60 and/or the payer 40 are notified of the positive verification as illustrated in FIG. 3 of the drawings. If the payee 20 is not verified, the payer 40 and/or payee 20 are notified of the negative verification.

3. Payee Confirmation.

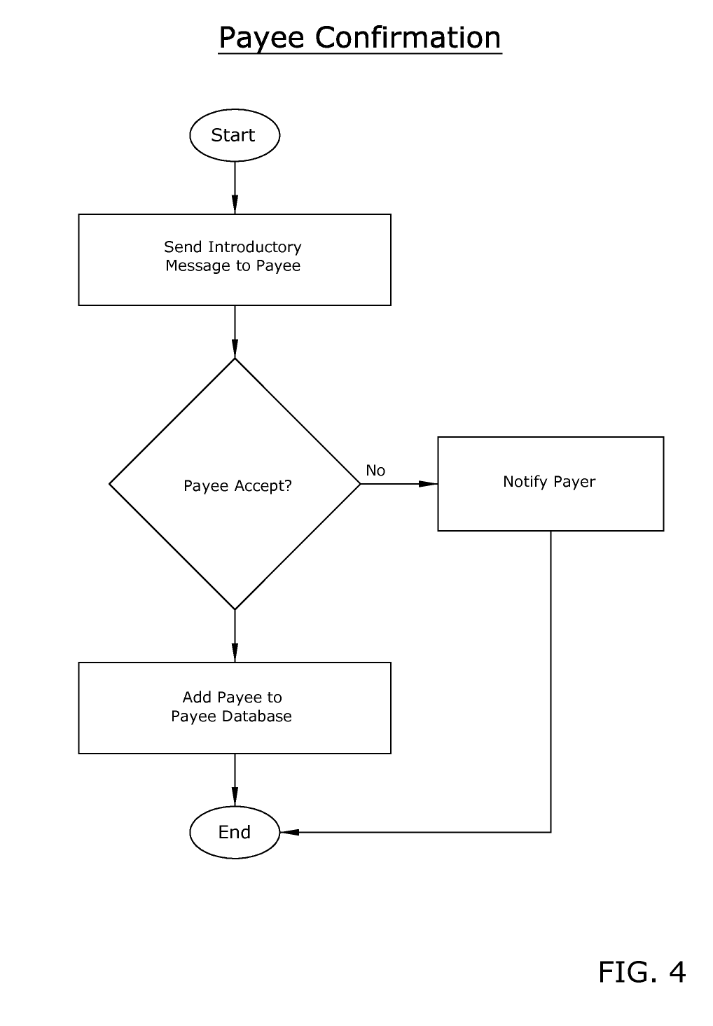

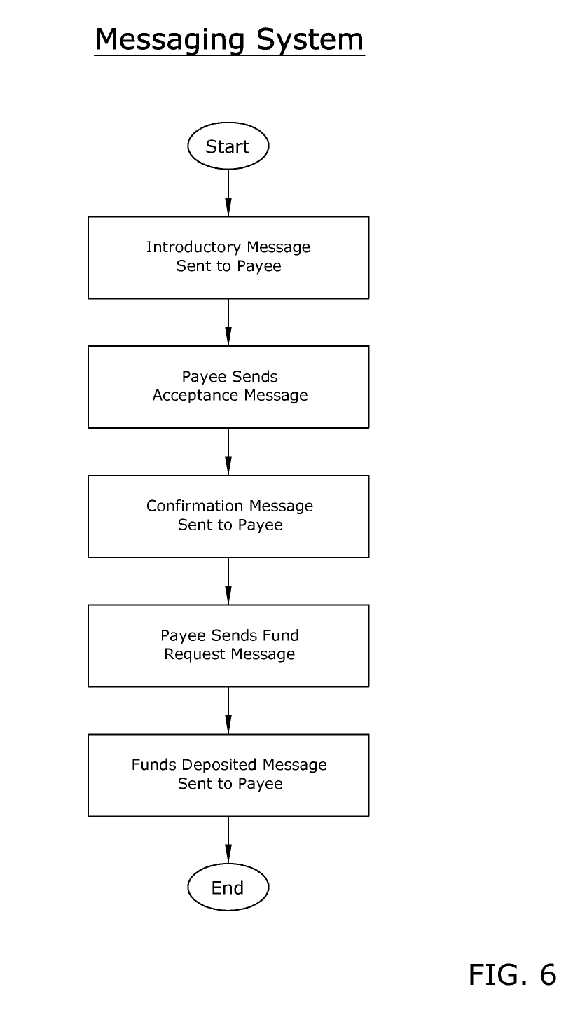

Once the payee 20 is verified, an introductory message 50 is sent to the payee 20 to verify the mobile phone number provided by the payee 20 and to invite (and verify) that the person associated with the mobile phone wants to participate in the fund transfer system. FIG. 4 illustrates the overall process for the confirmation of the payee 20 and FIG. 7a illustrates an exemplary introductory message 50 comprised of a text message sent to the payee device 22 comprised of a mobile phone or other mobile device. FIG. 6 illustrates the overall process of sending the introductory message 50 to the payee 20 and accepting the introductory message 50.

The text message may be displayed on the payee device 22 via a conventional text messaging application or via a mobile phone application the payee 20 installs on the payee device 22. As further shown in FIG. 7a of the drawings, a short code number 26 is preferably utilized by the sender of the introductory message 50 (e.g. control center 70, EFT service provider 60, payer 40) of the introductory message 50 that it utilized by both the payee 20 and the sender to communicate regarding future fund requests and fund transfers. The introductory message 50 is preferably transmitted by the control center 70 via the control center device 72.

The payee 20 has the option of (a) not replying to the introductory message 50, (b) replying to the introductory message 50 accepting the invitation such as replying with “Y” or “YES”, (c) replying to the introductory message 50 canceling the invitation such as replying with “N”, “NO” or “STOP”, or (d) replying with a request for help such as replying with “HELP”.

If the payee 20 accepts the invitation, the payee 20 is added to the payee database 12 and activated in the payee database 12 so that fund requests from the payee 20 may be honored. In addition, a confirmation message 52 is sent to the payee 20 indicating that they are now subscribed to the system as illustrated in FIG. 7c of the drawings. The confirmation message 52 preferably includes instructions on how to request funds by the payee 20 along with a security code required to be included with the request. For example, the security code could be “FLASH1234” and the request for $200 could be “AMT200” wherein the payee 20 would send a text message to the short code number 26 comprised of “FLASH1234 AMT200” to request a funds transfer from payer 40 to payee 20 of $200. As a further example, the payee 20 can send a text message to the short code number 26 comprised of “FLASH1234 AMT100” to request a funds transfer from payer 40 to payee 20 of $100. It is preferable that a code be placed in front of or behind the requested amount of funds to be transferred such as but not limited to “AMT” as illustrated in FIG. 7d of the drawings.

If the payee 20 denies/cancels the invitation, the payer 40 is notified of the denial/cancellation and the payee 20 is automatically sent a reply text message indicating that the payee 20 has not been added to the system. In addition, the payee 20 is not added to the payee database 12 thereby not allowing future funds requests by the payee 20.

If the payee 20 requests help by sending a text message via the payee device 22, various types of help information is automatically sent to the payee 20. For example, a reply text from the control center 70 may be sent to the payee 20 that includes a support telephone number for the payee 20 to call for assistance, a website URL for help or further instructions on using the automated system.

4. Funds Request.

FIGS. 4 and 6 illustrate an exemplary process for requesting funds by the payee 20 from the payer 40. In the preferred embodiment, the payee device 22 is comprised of a mobile device capable of sending and receiving text messages over the telecommunications network 10 such as but not limited to a smartphone). Various protocols may be utilized for the text messages such as but not limited to MMS, TMS or SMS.

When the payee 20 requires funds in their account, the payee 20 requests funds by sending a funds request message 53 to the control center 70 (e.g. text message) from the payee device 22. FIG. 7d illustrates an exemplary funds request message 53 comprised of the security code followed by the amount of the funds request (e.g. “FLASH12345 AMT200” indicating a request of $200). Alternatively, the payee 20 may only have to provide a security code in the funds request message 53 when a predetermined funds transfer amount (e.g. $100) has been agreed to between the payer 40 and the payee 20. The security code is used in combination with the mobile phone number of the payee device 22 to identify the payee 20 and also to identify the payer 40 for which the funds request is being made to. The payee 20 may only have one payer 40 associated with the payee's account with the control center 70 or multiple payers 40 associated with the payee's account with the control center 70. When multiple payers 40 are associated with the payee 20, the security code is utilized to identify which of the payers 40 the funds request is being made to.

The control center 70 accesses the payee database 12 to identify the payee 20 utilizing the mobile phone number used to send the funds request message 53 along with the security code. The control center 70 determines if a match can be found within the payee database 12 with the mobile phone number associated with the payee device 22 and/or the security code provided by the payee 20. If the payee 20 cannot be identified in the payee database 12, a message may be transmitted to the requesting party that they cannot be located within the system and instruct them to contact the payer 40.

If the payee 20 is identified as a valid payee 20 within the payee database 12, the control center 70 then determines if the payee 20 is preapproved to receive funds from the payer 40 and if the funds request by the payee 20 is within the transfer limits currently set by the payer 40 within the payee database 12. The control center 70 can also request confirmation directly from the payer 40, however, it is preferable that the payee database 12 be utilized to determine if the funds request should be authorized or denied to expedite the financial transaction. If the payee 20 is not preapproved to receive funds from the payer 40, the payer 40 may be requested by the control center 70 to authorize the transfer of funds to the payee 20.

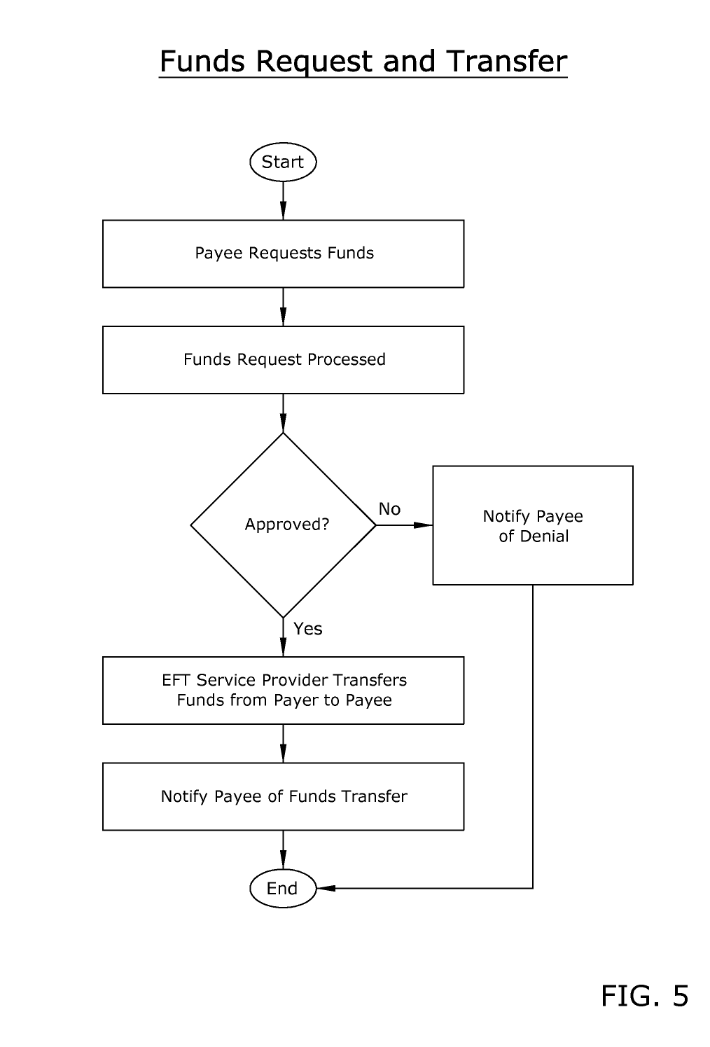

If the funds request by the payee 20 exceeds the transfer limits, the control center 70 denies the funds transfer and notifies the payee 20 of the denial as illustrated in FIG. 5. If the funds request by the payee 20 is within the transfer limits, the control center 70 approves funds transfer. In approving the funds transfer, the control center 70 notifies the EFT service provider 60 to transfer the funds from the financial account of the payer 40 to the financial account of the payee 20.

5. Funds Transfer.

After receiving the approval and notice of funds transfer from the control center 70, the EFT service provider 60 initiates the funds transfer from the payer 40 to the payee 20 via the financial network 10. It is preferable that the EFT service provider 60 utilizes an interbank network 10 to transfer the funds via an interbank transfer to expedite the funds transfer in a low cost manner. The interbank transfer occurs within a few minutes (e.g. preferably less than 15 minutes) of the funds request by the payee 20.

Once the interbank transfer is completed with the funds transferred to the financial account of the payee 20, the EFT service provider 60 notifies the control center 70 and the control center 70 notifies the payee 20 of the successful funds transfer via text message such as illustrated in FIG. 7e of the drawings. The payee 20 then will have immediate access to the transferred funds in the payee's account.

6. Funds Settlement.

The EFT service provider 60 will typically transfer the funds to the payee 20 from a financial account used by the control center 70 so the EFT service provider 60 does not have to access multiple different accounts for the payer's associated with the control center 70. The control center 70 may or may not have an advanced amount of funds from the payer 40 to offset the transfers out of the account of the control center 70.

The control center 70 will then periodically settle with each payer 40 such as at the end of each day to replenish the funds transferred on behalf of the payer 40 (e.g. transferring funds from a financial account of each payer 40 to a financial account of the control center 70). Alternatively, the EFT service provider 60 may transfer the funds directly from the payer 40 (or a financial account of the payer 40) to the payee's account.

### L. Customer Initiated Payment.

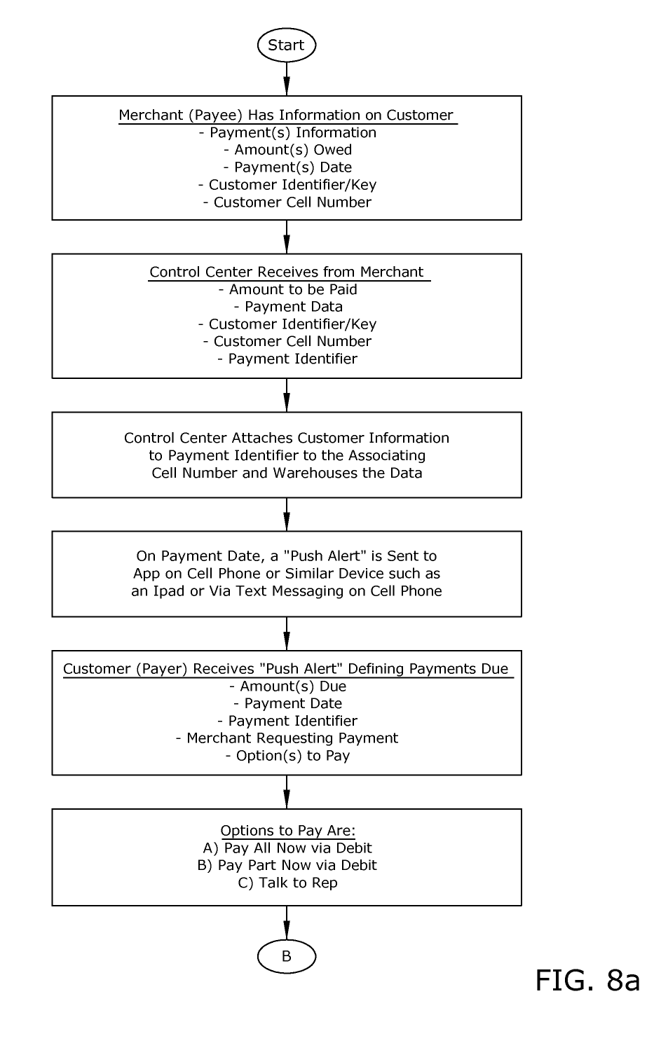

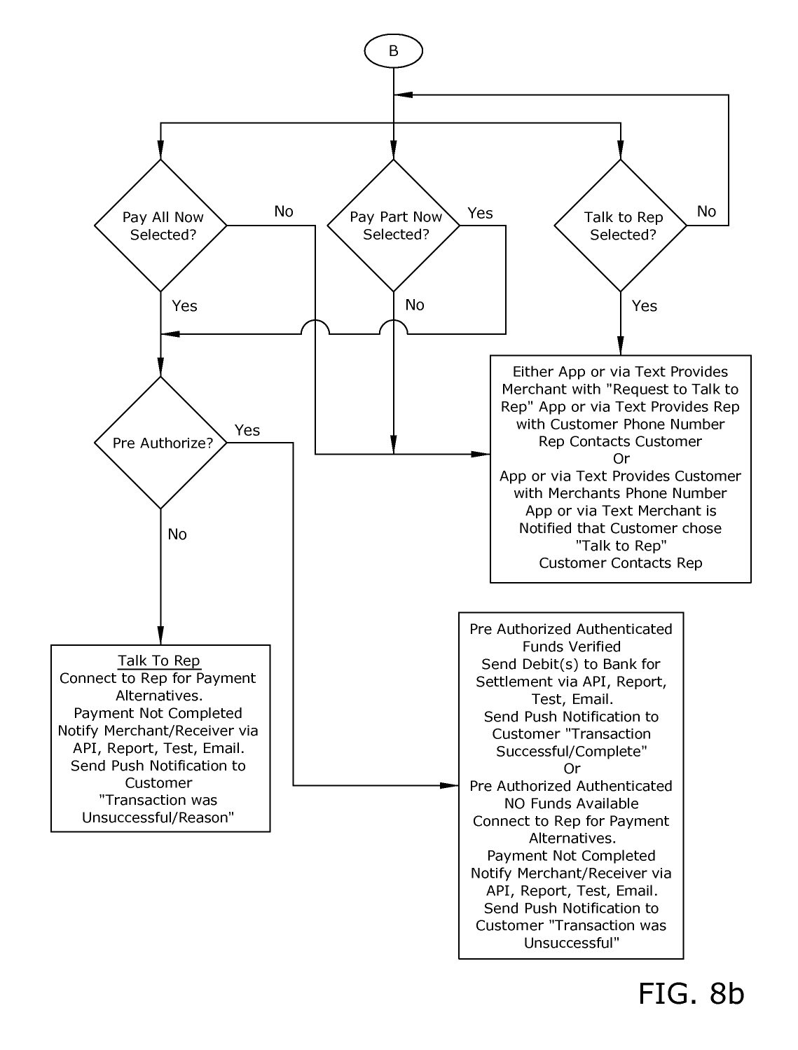

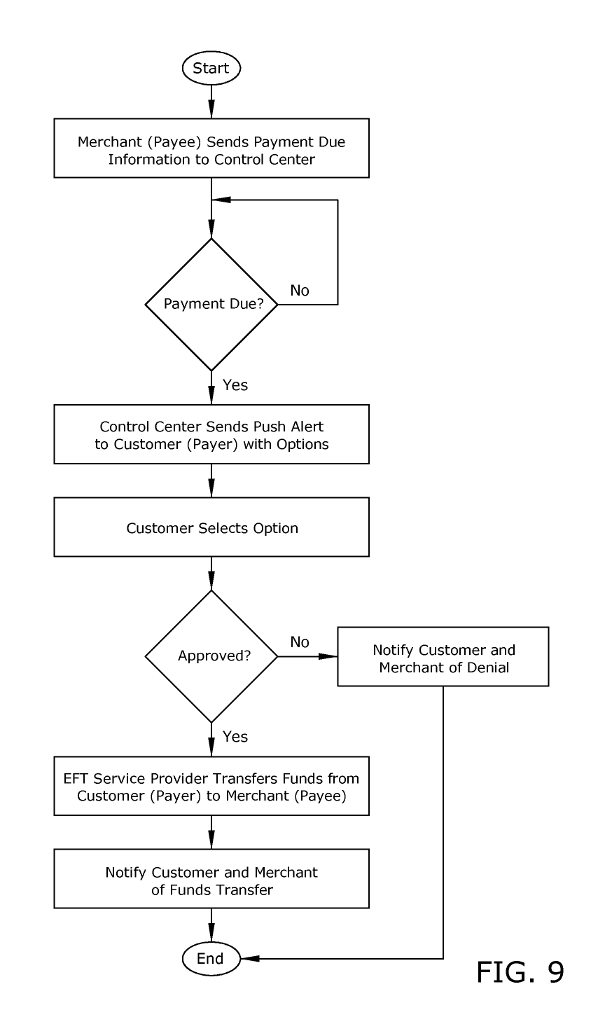

FIGS. 8a through 9 illustrate an invention similar to the invention discussed above that allows for a customer initiated payment to be made from a customer (i.e. payer 40) to a merchant (i.e. payee 20). The process in FIGS. 8a through 9 provide the customer (i.e. payer 40) with the ability to initiate a payment (e.g. repay an advance made to the customer by the merchant; make a loan payment; etc.).

The customer may download and utilize a software application from the merchant or the control center 70 on their payer device 42 (e.g. mobile device, smart phone, computer). Alternatively, the customer may use a text messaging service (e.g. Short Message Service referred to as SMS or Multimedia Messaging Service referred to as MMS). In either case, the payment facilitator (i.e. control center 70) pushes the payment amount on the due date via the point of sale (POS) rails instantly to the specific merchant with the following assumptions:
The payment facilitator (e.g. control center 70, EFT Service Provider 60 and/or payee/merchant) has the following information:
   Customer key or form of ID number for the customer;
   Cell number of customer;
   BIN & account number of customer; and
   Information as to whether the customer is a software application user or a text messaging system user for push alerts.
The payee/merchant provides the payment facilitator with the following information:
   Payment Information such as payment amount(s), principle, interest, fees, invoice number(s) and related information;
      Merchant determines one payment amount or alternatively multiple payment amounts;
   Payment due date; and
   Customer key or form of ID number for the customer.

Below is a summary of the steps illustrated in FIGS. 8a through 8b:
1. On the payment due date or at a predetermined advance date before the payment date (e.g. 5 days before the payment due date), the merchant sends a notification (with payment facilitator provider information) to the payment facilitator (e.g. control center 70) that the payment(s) is due, etc. The payment facilitator determines if the customer is a software application user or a text messaging system user.
2. Payment facilitator (i.e. control center 70) sends “Push Notification” to customer that payment(s) is due using the communication system identified for the customer (e.g. a text message is sent if the customer uses a text messaging system to communicate with). Defining payment amount(s) with request to “Pay Now”? If “No” the customer is directed to a representative or a message is sent to merchant to call Customer to arrange alternative payment options.
3. Pay Now has a YES response, through the POS rails the payment facilitator pre authorizes and/or verifies the account has sufficient funds to make the payment(s). If there is inadequate funds in the account the customer is directed to representative or a message is sent to Merchant to call Customer to arrange alternative payment options, if sufficient funds.
4. If sufficient funds the payments are presented for settlement, funds moved from customer account to Merchant settlement account via POS rails.
5. Payment is complete and notification sent to merchant.

Below is an overall illustration of the process illustrated in FIGS. 8a and 8b.

### Merchant/Receiver Has Customer Information and Payment Information

The merchant (i.e. payee 20) is presumed to have information relating to the consumer and the payment information by the consumer such as but not limited to the following information:
Payment(s) information;
Amount(s) owed;
Payment(s) date;
Payment identifier;
Customer identifier/key; and/or
Customer cell number.
   Control Center Receives from Merchant

The control center 70 receives the customer information and the payment information via the network 10 such as but not limited to the following information:
Payment(s) information;
Amount(s) owed;
Payment(s) date;
Payment identifier;
Customer identifier/key; and/or
Customer cell number.

### Customer Data Stored by Control Center

The control center 70 attaches the customer information and payment information to payment identifier to the associating cell number of the customer and warehouses/stores the data in a database on the control center device 72.

### Push Alert Sent to Customer

On the payment due date, a “Push Alert” is sent to the payer device 42 (e.g. the customer's smart phone) either via the software application on the payer device 42 or via the text messaging system on the payer device 42. The push alert is sent by the control center device 72 or the payee device 22 (e.g. the merchant's server computer). The customer reviews the information in the push alert displayed on the screen of the payer device 42. The information included in the push alert includes payment(s) due information and options on how to pay the merchant by the customer. For example, the customer may receive the following information in the push alert:
Amount(s) due;
Payment due date;
Payment identifier;
Name and/or identifier of merchant requesting payment from customer; and/or
Option(s) for the customer to pay the merchant such as but not limited to:
   Pay All Now via Debit;
   Pay Part Now via Debit; and/or
   Talk to Rep.

FIG. 9 also illustrates the overall alternative embodiment process for the customer (i.e. the payer 40) to make a payment to a merchant (i.e. the payee 20). The above processes used for transferring funds from a payer 40 to a payee 20 as illustrated in FIGS. 1 through 7e and the associated description above may be utilized with the alternative embodiment illustrated in FIGS. 8a through 9 of the drawings.

As shown in FIG. 9 of the drawings, the merchant (i.e. payee 20) sends payment due information to the control center 70 via the payee device 22 (e.g. computer) communicating with the control center device 72 (e.g. computer) through the network 10. The payment due information may include various types of information such as but not limited to merchant identifier/key, merchant identification information, payment(s) information, amount(s) owed, the payment(s) amount, payment(s) due date, customer identifier/key, customer mobile phone number, customer identification information and the like.

As further shown in FIG. 9, on the payment due date (or a predetermined period of time prior to the payment due date), the control center 70 sends a push alert to the customer (i.e. payer 40) regarding the payment due via the control center device 72 communicating with the payer device 42 (e.g. mobile phone, smart phone, computer) through the network 10. The push alert is displayed on the screen of the payer device 42 informing the customer of the amount(s) due, the payment due date, any payment identifier, the merchant identity and options. If the customer is utilizing a software application, the software application displays the push alert on the screen of the payer device 42. If the customer is utilizing a text messaging system, the push alert is displayed on the screen of the payer device 42 via the text messaging application on the payer device 42. For example, the following push alert may be provided to the customer via the payer device 42 (via the software application or text messaging system):

### Example Push Alert Displayed on Payee Device 42

Payment Due Alert

Amount Due: $231.32

Payment ID: 0021201

Merchant: Excalibur, Inc.

Options to Pay (select one option by responding with the corresponding letter):
Option A: Pay All Now Via Debit
Option B: Pay Part Now Via Debit ($100.00)
Option C: Pay Part Now Via Debit (Custom)
Option D: Talk to Representative

The customer then selects one of the options listed. If using a software application, the customer may select the option via a button on the display screen 24 of the payer device 42. If using a text messaging service, the customer may select the option by replying with the option identifier (e.g. A, B, C or D for the example above). In addition, the customer (i.e. the payer 40) may include a security code in the reply message.

If the customer selects Option A in the example above to pay all of the amount due via their debit card, then the control center 70 determines if the payment amount selected is preauthorized for a funds transfer from the payer financial institution to the payee financial institution 30. For example, if the customer selected Option A to pay the entire amount due ($231.32), the control center 70 verifies whether or not the customer has preauthorized a funds transfer of $231.32 or greater to Excalibur, Inc. If the amount selected to pay by the customer is preauthorized by the customer to transfer, then $231.32 is transferred by the EFT service provider 60 by the EFT service provider device 62 to the payee financial institution device 32. The funds transferred by the EFT service provider 60 preferably are transferred from a financial account associated with the control center 70 as discussed previously. The control center 70 notifies the customer via another push alert to the payer device 42 that the payment has been made and also notifies the merchant that the payment has been made. The control center 70 then settles with the payer 40 (i.e. the customer) later to replenish the financial account of the control center 70.

If the customer selects Option B in the example above to pay only a predefined partial amount via their debit card, then the control center 70 determines if the payment amount selected is preauthorized for a funds transfer from the payer financial institution to the payee financial institution 30. For example, if the customer selected Option B to pay only $100.00 on the amount due ($231.32), the control center 70 verifies whether or not the customer has preauthorized a funds transfer of $100.00 or greater to Excalibur, Inc. If the amount selected to pay by the customer is preauthorized by the customer to transfer, then $100.00 is transferred by the EFT service provider 60 by the EFT service provider device 62 to the payee financial institution device 32. The funds transferred by the EFT service provider 60 preferably are transferred from a financial account associated with the control center 70 as discussed previously. The control center 70 notifies the customer via another push alert to the payer device 42 that the payment has been made and also notifies the merchant that the payment has been made. The control center 70 then settles with the payer 40 (i.e. the customer) later to replenish the financial account of the control center 70.

If the customer selects Option C in the example above to pay only a custom partial amount via their debit card, the customer will either enter the custom amount they would like to pay with this selection (e.g. “C: $25.00”) in a reply message to the control center 70 or they only select Option C where after the control center 70 then requests from the customer the amount they would like to pay (the customer would then reply with $25.00 or another custom amount they would like to pay). The control center 70 then determines if the partial custom payment amount is preauthorized for a funds transfer from the payer financial institution to the payee financial institution 30. For example, if the customer selected Option C to pay only $25.00 on the amount due ($231.32), the control center verifies whether or not the customer has preauthorized a funds transfer of $25.00 or greater to Excalibur, Inc. If the amount selected to pay by the customer is preauthorized by the customer to transfer, then $25.00 is transferred by the EFT service provider 60 by the EFT service provider device 62 to the payee financial institution device 32. The funds transferred by the EFT service provider 60 preferably are transferred from a financial account associated with the control center 70 as discussed previously. The control center 70 notifies the customer via another push alert to the payer device 42 that the payment has been made and also notifies the merchant that the payment has been made. The control center 70 then settles with the payer 40 (i.e. the customer) later to replenish the financial account of the control center 70.

As with the prior embodiment, it is preferable that the EFT service provider 60 utilizes an interbank network 10 to transfer the funds via an interbank transfer to expedite the funds transfer in a low cost manner. The interbank transfer occurs within a few minutes (e.g. preferably less than 15 minutes) of the funds request by the payee 20.

If the customer selects Option D to Talk to Representative, the payment is not made by the customer and the customer is instead connected to a representative for payment alternatives (e.g. the merchant calls the customer, the merchant does an online chat with the customer, etc.). The customer works out the details regarding paying the amount due accordingly.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other embodiments of the invention will come to mind to one skilled in the art to which this invention pertains and having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The invention claimed is:

1. A method of receiving and fulfilling an electronic funds transfer request by a payee, comprising:
receiving at a control computer payee information, payer information and payment information from a payee device, wherein said payment information is associated with said payer information, and wherein said payment information includes a payment due date;
sending an alert to a payer device associated with said payer information from said control computer, wherein said alert includes said payment information;
receiving at said control computer a funds transfer request from said payer device requesting the transfer of a requested transfer amount to said payee from said payer;
identifying a payer, said payer information associated with said payer, a payee, and said payee information associated with said payee by said control computer;
determining if said funds transfer request should be approved or denied by said control computer; and
transferring funds by interbank transfer to a payee account of said payee when said funds transfer request is approved.

2. The method of claim 1, wherein said alert is comprised of a push alert.

3. The method of claim 2, wherein said alert is comprised of a message sent to a software application on said payer device.

4. The method of claim 1, wherein said alert is comprised of a text message.

5. The method of claim 1, wherein said payer device is comprised of a mobile device.

6. The method of claim 5, wherein said payer device is comprised of a smart phone.

7. The method of claim 1, wherein said funds request message is comprised of a text message sent from said payer device to said control center via a text messaging service.

8. The method of claim 1, wherein said requested transfer amount is comprised of a predetermined amount included as an option in said alert.

9. The method of claim 1, wherein said requested transfer amount is comprised of a customized amount set by said payer.

10. The method of claim 9, wherein said customized amount is included in said funds transfer request.

11. The method of claim 1, wherein said funds request message includes a security code.

12. The method of claim 11, wherein said security code is utilized to identify said payee.

13. The method of claim 11, wherein said security code is utilized to identify said payer.

14. The method of claim 1, wherein said step of sending an alert to a payer device occurs on a payment due date.

15. The method of claim 1, wherein said payer device is comprised of a mobile phone having a mobile phone number.

16. The method of claim 1, wherein said interbank transfer occurs less than 15 minutes after said step of receiving a funds transfer request.

17. The method of claim 1, including the step of sending a confirmation message to said payee device via text message after said step of transferring funds has been completed.

18. The method of claim 1, wherein said payment information is comprised of an amount due and a payer identifier.

19. The method of claim 18, wherein said payment information includes a payment due date.

20. The method of claim 19, wherein said payment information includes a payment identifier.
